(19) United States
(12) Patent Application Publication
(10) Pub. No.: US 2005/0099532 A1
(43) Pub. Date: May 12, 2005

(54) Image pickup device and a manufacturing method thereof

(76) Inventor: Shih-Hsien Tseng, Hsinchu (TW)

Correspondence Address: PRO-TECHTOR INTERNATIONAL, 20775 Norada Court, Saratoga, CA, 95070-3018, US

(21) Appl. No.: 10/712,315

(22) Filed: Nov. 12, 2003

(30) Foreign Application Priority Data
Nov. 10, 2003 (TW) 92131372

(51) Int. Cl. H04N 5/225

(52) U.S. Cl. 348/374; 348/340

(57) ABSTRACT

The thin image pickup device has a substrate, an electromagnetic receiving area thereon as photoelectric converting elements, a peripheral circuit, and embedded trenches passing through the substrate and filled with conductive materials for forming stitching plugs. The stitching studs are formed from the stitching plugs after a lower surface of the substrate being thinned, and serve as electrode connecting terminals of the image pickup device.

### BACKGROUND

1. Field of Invention

The present invention relates to an image pickup device. More particularly, the present invention relates to a thin image pickup device manufactured by using a whole wafer, and one or more image producing steps that thin the image substrate and cover the optical transparent window directly. Furthermore, an optical lens system, a solid-state image pickup device, an image control module, a flexible conductive element and other devices are integrally assembled in a compact imaging module device suitable for integration into a unit of portable electronic equipment.

2. Description of Related Art

Generally, an image pickup device is mounted in a ceramic or plastic package on a flexible or plastic circuit board by wiring or bumping pads of the image pickup device to inner leads of the package, and thus forming an image pickup device. The image pickup device typically comprises a photoelectric transducer element fabricated on an upper surface of a solid-state semiconductor substrate, which is capable of converting incident electromagnetic radiation energy thereon into an electronic charge and then transforming the same into a controlled electrical voltage signal. Moreover, a pixel addressing control circuit decodes active pixel elements of the photoelectric transducer array and a peripheral control circuit is also provided for a signal output from the image pickup device.

The image pickup device is individually assembled and hermetically sealed in the ceramic or plastic package having signal lead terminals and a cover glass, plastic lid or window that exposes the top of the photoelectric transducer element of the image pickup device. FIG. 1 illustrates a schematic view of a conventional image pickup device and package. As illustrated in FIG. 1, a conventional ceramic package 100 is provided with a recess 101 on a ceramic substrate 103 and a conductive inner lead 102 therein. An image pickup device 104 is attached inside the recess 101 with a conductive adhesive film 105, and a standard wire bonding process is used to connect electrode pads 106 of the image pickup device 104 to the inner leads 102 with metal wires 107.

FIG. 2 illustrates a schematic view of another conventional image pickup device and its package. In FIG. 2, a resin package 110 has an electrical connecting molded lead frame 117 comprising inner leads 112 and outer leads 122, and a recess 111 on a resin substrate 113. An image pickup device 104 is attached inside the recess 111 by a conductive adhesive film 115, and a wire bonding process is also used to connect electrode pads 106 of the image pickup device 104 to the inner leads 112 with metal wires 107.

Another low cost image package is disclosed in U.S. Pat. No. 6,268,231, entitled “Low cost CCD packaging” and issued on Oct. 14, 1999 to Keith E. Wetzel, as illustrated in FIG. 3. A CCD package 310 includes a plastic base structure 312, a plastic ring frame 314, a flexible circuit board 318 and a cover glass 316 to form a hermetic housing, in order to contain and assemble an image pickup device inside it. The cover glass 316 is used to protect the image sensor chip 311 attached on the flexible circuit board 318 inside the hermetic housing. Conductive leads of the flexible circuit board 318 are electrically connected to electrode pads of the image sensor chip 311 by metal bonding wires 329.

The major disadvantages of the conventional image pickup device are that it is manufactured by individual assembling processes, without thinning the image pickup substrate before the sequential assembling steps, complicated wire bonding steps are required, thus increasing the overall manufacturing cost and cycle time, and it is further difficult to miniaturize the size and weight thereof. Generally, multiple image pickup devices of the solid-state wafer need to be first separated therefrom into single individual image pickup devices. However, during the wafer singulation, the induced silicon particles tend to contaminate and scratch the photoelectric transducer area of the image pickup device and thereby damage or destroy the image pickup device, thus affecting the overall assembling yield and quality of the image pickup devices.

As portable electronic equipment becomes smaller, lighter, and thinner, it is critical to miniaturize the size of the image pickup device integrated in the portable electronic equipment. The conventional image pickup device described above requires a housing, supporting the transparent glass and maintaining a space for containing and protecting wire bonding loops thereof.

However, the housing is relatively bulky and has to extend upwards from the circuit board with a significant distance of at least a couple of millimeter (mm). Moreover, trapped moisture inside the housing causes failure and lowers the sensitivity of the image pickup device. As the function and quality performance of the image pickup device improve following the demands of new various multimedia applications of portable electronics equipments, a number of optical lenses and peripheral signal control circuit components have to be included and assembled together.

Therefore, it is very difficult to assemble with precision a smaller and thinner image pickup device into an integrated and miniaturized image pickup module, including optical lens system and peripheral controlled devices to maintain the high quality and performance of the image pickup device.

The related-art imaging pickup module is illustrated in FIG. 4 involves a peripheral element 491, an imaging pickup element 492, and a circuit board 493. A wire bonding is carried out using a metal wire 494 for the electrical connection between the image pickup element 492 and the circuit board 493 in the resin housing having a cover glass 495 or IR filter adhered to the resin 496. Then a holder 497 having an optical lens 498 is mounted on the circuit board 493. However, there are some problems in maintaining precise alignment and focus between the image pickup element 492 and the optical lens 498, and a thickness of holder 497 and this imaging pickup module configuration are not suitable to make smaller and thinner imaging pickup modules.

In this way, the accuracy of positioning of the optical lens system with respect to the solid-state image pickup device is inferior to the conventional image pickup module, Furthermore, considering a moveable-type focal lens system, focusing of the moveable-type focal lens system with respect to the image pickup device is carried out by the focal length adjusting mechanism, which needs lens-barrels for focal length adjustment so that the image pickup module becomes large and complicated.

### SUMMARY

The present invention is provided to resolve the above-described concerns regarding image pickup devices and to disclose a cheap, thin and compact image pickup module for installation in a cellular phone, a personal computer, a video camera, a digital still camera, a personal digital assistant (PDA), a desktop scanner, a bar-code reader, a security scanner, or the like.

It is therefore an objective of the present invention to provide a thin image pickup device, which is easily assembled and flexibly mass produced on a whole wafer or a partial wafer with multiple image pickup devices, and is a miniaturized and highly integrated functional device.

It is another an objective of the present invention to provide an imaging module, which has fixed or adjustable optical lens system suitable for installation on a portable electronic device, such as a mobile telephone or a personal digital assistant.

It is still another an objective of the present invention to provide a manufacturing method of an image pickup device, which uses stitching studs to replace the conventional wirings and substantially thins the substrate, such that the image pickup device is more adaptable to the modern thin, light and small electronic device.

In accordance with foregoing and other objectives of the present invention, a thin image pickup device is provided. The thin image pickup device includes a substrate, an electromagnetic receiving area thereon as photoelectric converting elements, a peripheral circuit, and embedded trenches filled with conductive materials for forming stitching plugs. The stitching studs are formed from the stitching plugs after a lower surface of the substrate is thinned, and serves as electrode connecting terminals of the image pickup device.

In one preferred embodiment of the invention, a transparent window is attached onto the substrate, and located above the electromagnetic receiving area for improving the image quality. A sustain layer can be used to prevent the transparent window from damaging the photoelectric converting area and to control a pre-designed thickness between the photoelectric converting area and the transparent window, which are recognized as a partial image optical system implemented in the image pickup device. Moreover, a plurality of adhesive layers are provided for combining the transparent window, the sustain layer and the substrate.

The transparent window is attached directly onto an upper surface of the image pickup device of the invention, without additionally forming a housing to support the transparent window that protects the image pickup device. The transparent window can alternatively have one or two flat, spherical, aspherical, or Kinoform surfaces.

The surfaces of the transparent window are diffractive, refractive surfaces or hybrid surfaces, including flat, spherical, aspherical surfaces or any combination thereof to be refractive or diffractive optic elements, for performing an optical function of the optical lens system. The surfaces also can be formed with at least one film to provide IR and/or low pass filter features. When the transparent window is subjected to optical filter treatment, it need not be re-matched with a new optical filter and a new cover glass on the image pickup device.

The transparent window is attached onto the upper surface of the image pickup device with an adhesive film directly and/or combined with sustain layer. For completely tightening the lower surface of transparent window and the top surface of the image pickup device, holes and/or extrusions can be provided on the image pickup device, the sustain layer, the adhesive layer and the transparent window for a precise alignment between the image pickup device and the transparent window.

Furthermore, in another embodiment of the invention, a transparent material fills a cavity between the upper surface of the photoelectric converting area and the lower surface of the transparent window. The transparent material matches a reflective index of the transparent window to reduce the reflection loss between the image pickup device and the transparent window directly attached thereto. This configuration achieves the image formation on the photoelectric converting elements through the transparent window and/or the transparent material filler.

Thereafter, the substrate is thinned directly from the lower surface thereof by using conventional backgrinding and/or subsequent polishing, such as chemical-mechanical polishing, high selective plasma etching, or wet etching steps, to expose the embedded deep metal plugs to be the stitching studs, which are electrode connecting terminals of the image pickup device.

The embedded deep metal plugs are formed from the embedded trenches dug in the upper surface of the substrate by plasma etching, wet etching, laser drilling or any combination thereof, and then depositing the insulating films, such as silicon dioxide, silicon nitride, other insulating films or any combination thereof, by alternative techniques to form on the sidewall of the embedded trenches.

The embedded trenches are then filled with conductive materials, such as insulating films made of titanium, titanium nitride, aluminum, copper, mercury, tungsten, amalgam, silver epoxy, solder, conductive polymer, other conductive material or their combinations, for example.

In the manufacturing method, a plurality of stitching studs are formed from the lower surface of the substrate as external electrode connecting terminals without increasing the weight or bulk of the package. More particularly, the method is not limited to using single image pickup packaging process; more flexible and efficient processes, such as a whole wafer or multiple image pickup devices assembling process, may also be used.

In other preferred embodiments, the invention provides several different ways for forming the stitching studs. The lower surface of the substrate is etched to form a plurality of backside trenches corresponding to and in contact with the frontside stitching plugs. An insulating film is formed on the sidewalls of the backside trenches and then the backside trenches are filled with a conductive material, thus forming backside stitching plugs. The backside stitching plugs are electrically connected to the frontside plugs, thus forming the stitching studs.

Conversely, it is possible to form the stitching studs directly from the lower backside as external electrode connecting terminals without increasing any weight or bulk of the package thereof. After thinning the substrate or not, the backside stitching stud is formed by a single backside trench which passes thorough the substrate from the lower surface to the upper surface thereof, and is also covered with an insulating film. The stitching stud is connected to an electrical connection layer whose material is a poly layer or polycide, a contact plug, or a metal layer fabricated in the image pickup device.

Furthermore, in another preferred embodiment, an electrical connecting configuration is provided to connect electrically the stitching studs to electrode ports of an image control module, which has highly integrated image related control functional blocks, such as system micro controllers, digital signal processing units, system timing ASICs, memory buffers and peripheral controller devices, or has integrated image system control module packages including the preceding functionality.

Several packaging connection techniques and materials, such as an isotropic conductive adhesive used in the studs bumping bonding, other conventional surface mounting, anisotropic connection film (ACF), gold or solder bumping, wiring, ball grid array, flexible cable and/or flip chip, can be used in the electrical connecting between the stitching studs and the electrode ports of the image control module, to be an integrated compact imaging module.

In keeping with the trend for portable electronic equipment, a requirement for a compact imaging module, used in multimedia, is greater than ever for integration into such equipment. Generally, an optical lens system is individually and fixedly combined with the lens holder configured on the substrate having the image pickup device by conventional assembling techniques. Or, a complicated zoom cam mechanism is used to adjust the focal length of the optical lens system with the respect to the image pickup device, where the large volume and complicated alignment are the main disadvantages.

The present invention also provides a cheap, compact, highly functional and producible imaging module, which has an easily assembled optical lens system with fixed focus or adjustable focus combined with the thin image pickup device manufactured by the foregoing method. By forming a plurality of image pickup modules simultaneously, labor to handle and produce the image pickup modules is less than that for the conventional method, which handles and produces the image pickup modules on an individual basis.

A plurality adhesive layers and optional sustain layers are formed in a stacked manner, which can be the lens holder for attaching and holding the optical lens system to and with respect to the transparent window configured on the substrate. The adhesive layers are deposited above the transparent window, then the sustain layers and other adhesive layers are optionally inserted for maintaining the pre-designed focal length. A precisely controlled focal length is thus available between the optical lens system and image pickup device.

The configuration of the invention is suitable for depositing the adhesive layers and inserting the sustain layers to match the transparent window and attach the optical lens system by manufacturing on a whole wafer or multiple image processes simultaneously. After that, each of the image pickup devices is separated to electrically connect to the electrode ports of the image control module, which includes and/or is bonded to a plurality of peripheral devices in a stacked or planar manner on its circuit board.

The configuration of the invention also achieves an adjustable focus imaging module by using flexible conductive element for electrical connecting between the image pickup device and the image control module, where the moveable focus imaging module includes the optical lens system and the image pickup device which are tightly combined with each other by a zoom mechanism or other techniques, such as mechanical technique, electromagnetic force or motors, to facilitate movement up and down of the image pickup device and/or the optical lens system for further improving the image performance and quality.

Other objects, features, and advantages of the present invention will become apparent upon consideration of the following detailed descript and accompanying drawings, in which like reference designations represent like features throughout the figures. It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 illustrates a schematic view of a conventional image pickup device and its package;

FIG. 2 illustrates a schematic view of another conventional image pickup device and its package;

FIG. 3 illustrates a schematic view of another conventional image pickup device and its package;

FIG. 4 illustrates a schematic view of prior art pickup module;

FIG. 5 illustrates a schematic view of a whole wafer having a plurality of image pickup devices;

FIG. 6 is a schematic view of the image chip in FIG. 5;

FIG. 7A to FIG. 7D are cross-sectional views along the line A-A′ in FIG. 6 for illustrating a manufacturing method of the stitching plugs;

FIG. 8 is a cross-sectional view along the line A-A′ of the image chip in FIG. 6 for interpreting the sequential processes after the step in FIG. 7D;

FIG. 9A and FIG. 9B are schematic views to illustrate fabrication steps of multiple image chips and the transparent windows attached thereto;

FIG. 10A and FIG. 10B illustrate schematic views of other preferred embodiments of the invention;

FIG. 11A and FIG. 11B illustrate schematic views of the substrate which are thinned from lower surfaces of the substrate in FIG. 10A and 10B, respectively;

FIG. 12A and FIG. 12B illustrate schematic views of another preferred embodiments of the invention;

FIG. 13A, FIG. 13B and FIG. 13C illustrate schematic views of three embodiments of the invention showing how to form the stitching studs in different ways;

FIG. 14A and FIG. 14B illustrate schematic views of preferred embodiments of the image pickup device associated with an image control module;

FIG. 15A and FIG. 15B illustrate schematic views of two embodiments of the imaging module of the invention, which have fixed focal lengths; and

FIG. 16A and FIG. 16B illustrate schematic views of two embodiments of the imaging module of the invention, which have adjustable focal lengths.

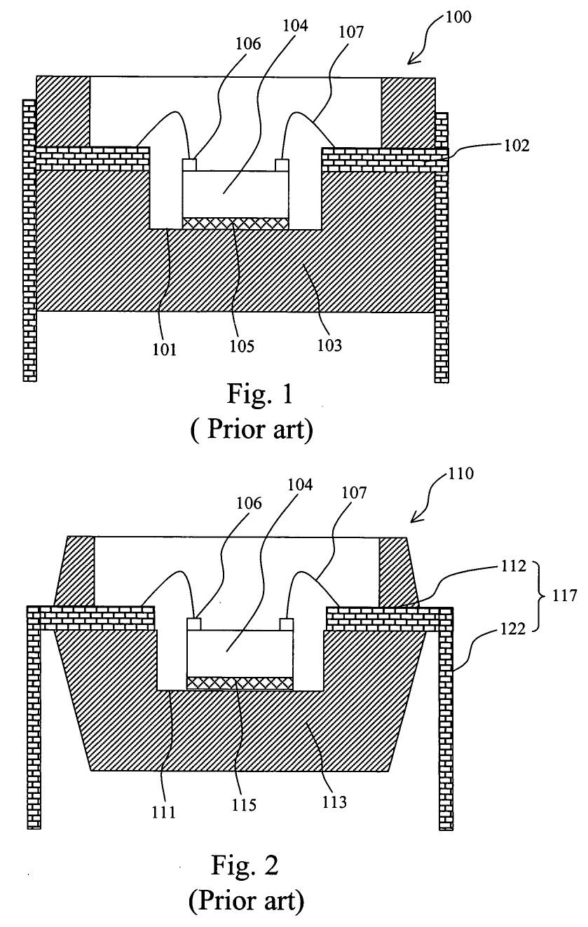

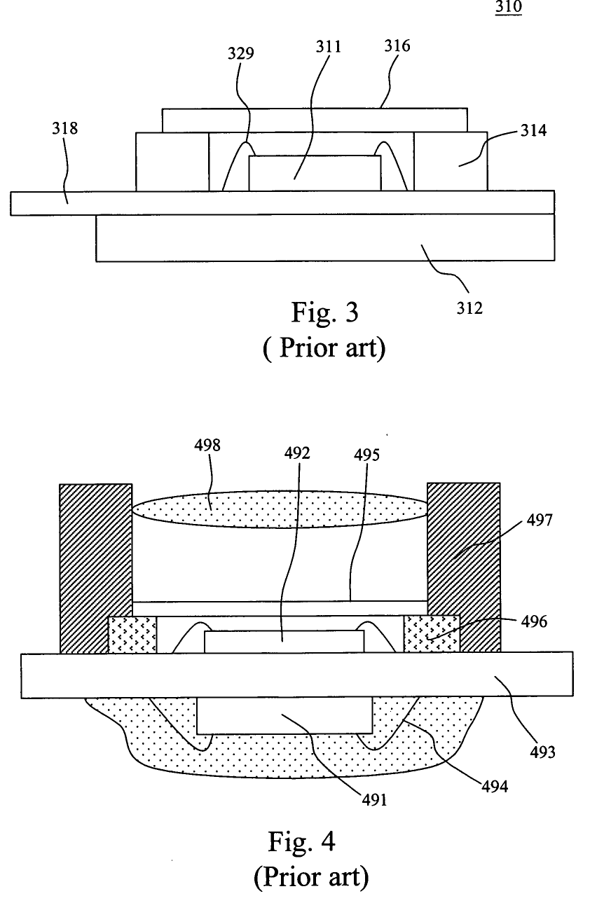

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

An image device includes a substrate, a photoelectric converting area, a transparent window and a plurality of stitching studs. The photoelectric converting area detects image radiation energy. The transparent window improves the image quality. The stitching studs on the bottom side of the substrate electrically connects to an image control module having highly integrated, other image-related function blocks, such as system microcontrollers, digital signal processing units, system timing ASICs, memory buffers and peripheral controller devices, or having integrated image system control module packages including the preceding functionality. Moreover, an optical lens system is provided to improve the image performance and quality and is fixedly or adjustably configured to the image pickup device.

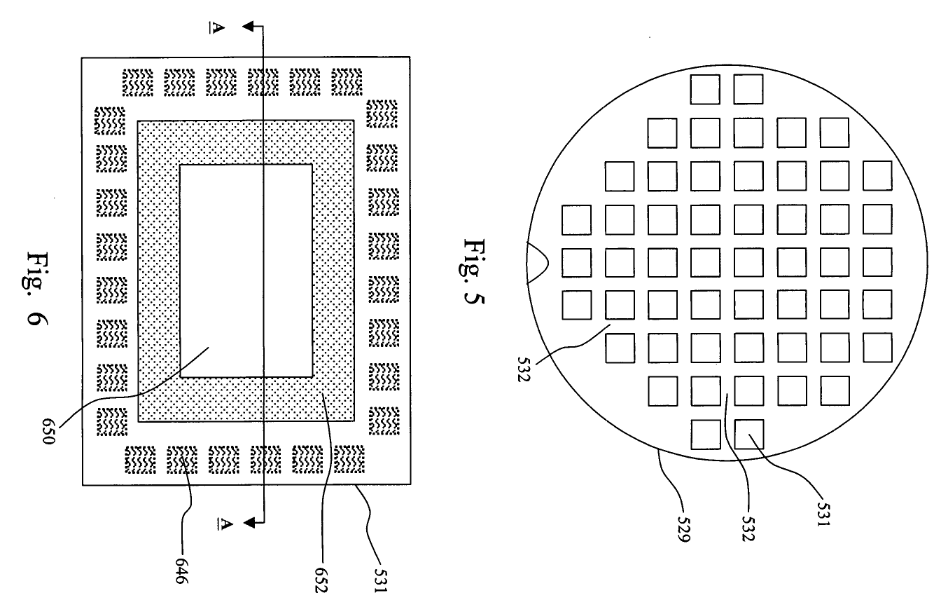

FIG. 5 illustrates a schematic view of a whole wafer having a plurality of image pickup devices. In FIG. 5, a whole wafer 529 is sliced from single crystal silicon ingot and manufactured with a CMOS image sensor (CIS) or a charge couple device (CCD) process. The wafer 529 comprises a plurality of image pickup devices, like image chips 531, and dice saw area 532 which is reserved for the wafer 529 being cut into the individual image chips 531.

FIG. 6 is a schematic view of the image chip in FIG. 5. As illustrated in FIG. 6, an image chip 531 has an electromagnetic receiving area, like a photoelectric converting elements 650 in the central location of the image chip 531, and a plurality of stitching plugs 646 near the perimeter of a peripheral circuit 652 thereof which is used for the conventional connection of electrical terminals to an image control module.

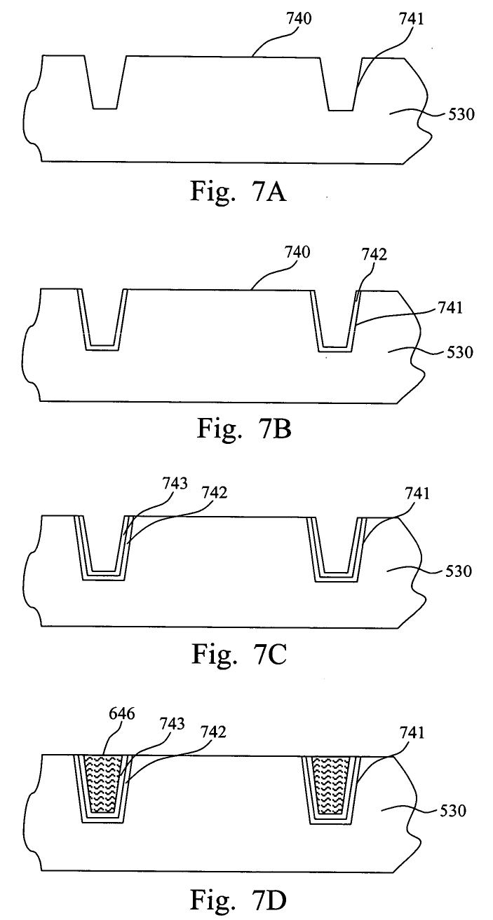

FIG. 7A to FIG. 7D are cross-sectional views taken along the line A-A′ in FIG. 6 for illustrating a manufacturing method of the stitching plugs. Referring to FIG. 7A, a substrate 530 is etched on an upper surface 740 thereof to form a plurality of trenches 741. In one embodiment of the present invention, the trenches 741 are formed on a silicon semiconductor substrate or other silicon semiconductor substrate with a sapphire layer, such as, for example, substrates used in a semiconductor over insulator (SOI) technology, or even other plastic or glass substrates.

As illustrated in FIG. 7B and FIG. 7C, for isolating the trenches 741, insulating films are formed inside the trenches 741, including an oxidization film 742 and/or an additional silicon nitride film 743. The trenches 741 are then filled with a conductive material to form the stitching plugs 646, in FIG. 7D. In one preferred embodiment of the invention, the conductive material is either titanium or titanium nitride when the electrical connecting plug is buried metals and tungsten. In other preferred embodiments, the conductive material is titanium, titanium nitride, aluminum, copper, mercury, tungsten, amalgam, silver epoxy, solder, conductive polymer, other conductive material, or combinations thereof.

Then, chemical mechanical polishing (CMP), wet etching, plasma etching back process or a combination thereof is applied to accomplish the isolated stitching plugs 646. Stitching plugs 646 embedded inside the substrate 530 are expected to be outer electrode pads after sequentially processing by the foregoing conventional solid-state process steps. Generally, the sequence of forming the isolated stitching plugs 646 is flexible in a whole manufacturing method of the image pickup device. For example, the step of forming the stitching plugs 646 can be carried out before or after the step of forming an interlayer dielectric layer (ILD), metals layers, forming contact or via layers, forming poly layers, or forming an photodiode active layer of the photoelectric converting elements 650.

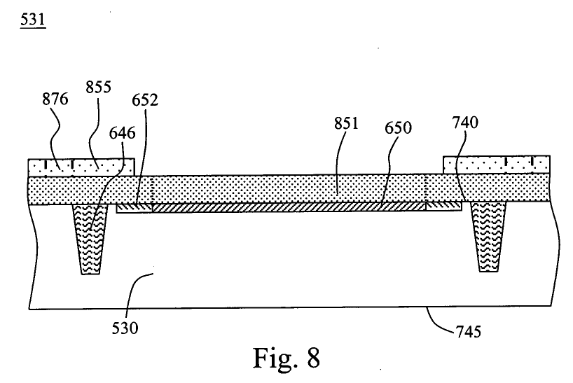

FIG. 8 is a cross-sectional view taken along the line A-A′ of the image chip in FIG. 6 for interpreting the sequential processes after the step illustrated in FIG. 7D. The photoelectric converting elements 650 are formed on the upper surface 740, and are generally located in the central region of the image chip 531. A peripheral circuit 652 for address decoding and signal processing is located in a peripheral region of the photoelectric converting elements 650, which has a large number of pixels (not shown) disposed in two dimensions.

Each pixel comprises a photodiode and a CMOS transistor for amplifying converted charges, and switching corresponding to the radiation amount of electromagnetic density. In addition, the peripheral circuit 652 also comprises a driving circuit for driving the pixels to obtain signal charges, an A/D converter for converting signal charges to digital signals, and a digital signals processing unit for forming image output signals.

Several inter-dielectric layers are located on the photoelectric converting elements 650 and the peripheral circuit 652. The inter-dielectric layers 851 may include a poly and/or metal. A color filter, a micro lens array layer (not illustrated in FIG. 8), or a passivation layer 855 is on the inter-dielectric layers 851. The inter-dielectric layers are formed by semiconductor processes, thus making the whole configuration become a fully functional image pickup device. In addition, the stitching plugs 646 are configured near the perimeter of the peripheral circuit 652, and arranged closely to each other.

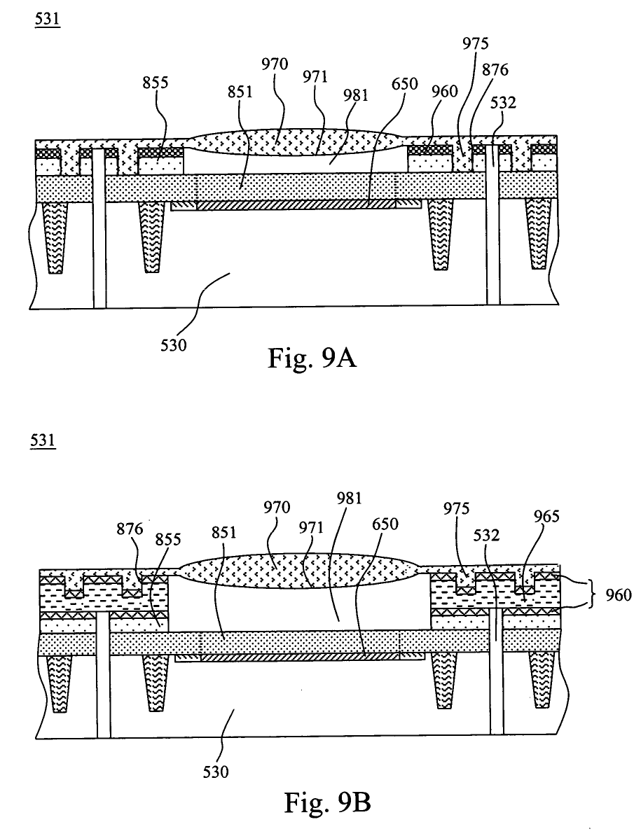

FIG. 9A and FIG. 9B are schematic views illustrating fabrication steps of multiple image chips and the transparent windows attached thereto. As illustrated in FIG. 9A, an adhesive layer 960 is sandwiched between the substrate 530 and the transparent window 970. In addition, as illustrated in FIG. 9B, the adhesive layer 960 also can optionally be inserted with a sustain layer 965 to prevent the transparent window 970 from damaging the photoelectric converting elements 650. The adhesive layer 960 also can be used between a passivation layer 855 and a lower surface 971 of the transparent window 970.

The transparent window 970 is matched with the substrate 530, either a whole wafer, or multiple or even single image chip, alternatively. The transparent window 970, protects the photoelectric converting elements 650, and improves the image performance thereof, as an IR filter, or a low pass filter.

Furthermore, the transparent window 970 may have one or two flat, spherical, aspherical, or Kinoform surfaces so as to be a diffractive or refractive optic element, or a further hybrid combined with flat, spherical and/or aspherical surfaces to be the refractive or diffractive optic element.

Color filters can be formed on the transparent window 970 to color the images while the image pickup device is a mono-color device. The alignment and adhesive portions can be integrally formed together between the substrate 530 and the transparent window 970, such as extrusions 975 of the transparent window 970 and holes 876 of the passivation layer 855 or the sustain layer 965, as illustrated in FIG. 9A and FIG. 9B. The extrusions 975 and the holes 876 are defined by the conventional semiconductor patterning and etching process, or glass or plastic molding process. It is also in keeping with the spirit of the invention to form the holes on the transparent window 970 for mechanical alignment with the extrusions of the substrate 530.

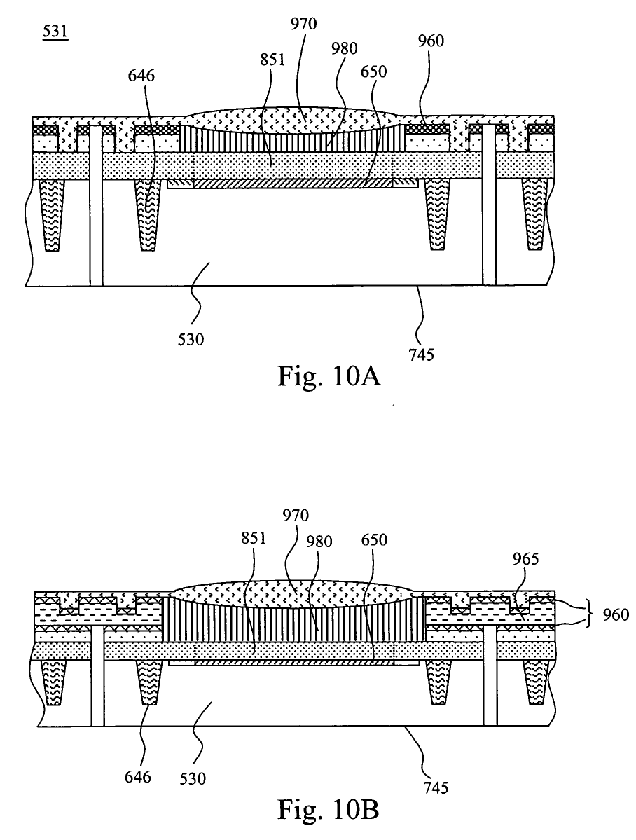

FIG. 10A and FIG. 10B illustrate schematic views of other preferred embodiments of the invention. In these preferred embodiment, a cavity 981 between the transparent window 970 and the inter-dielectric layers 851, is filled with transparent material 980 instead of air, as illustrated in FIG. 9A and FIG. 9B. The transparent material 980 can be silicone epoxy, silicon gel, polymer, polyimide, liquid crystal, plastic or other gases, which properly fill the cavity 981. More particularly, the transparent material 980 and the transparent window 970 protect the photoelectric converting elements 650 from dust and contaminants as so to improve the sensitivity of the photoelectric converting elements 650.

The substrate 530, the transparent window 970 and/or the transparent material 980 are combined by the adhesive layer 960, even when the sustain layer 965 or other adhesive layer is also used, such that the semi-manufactured device can be stored without a clean room before proceeding on to subsequent assembling procedures. In other words, the cost associated with the image pickup device of the invention is less than that in the prior arts.

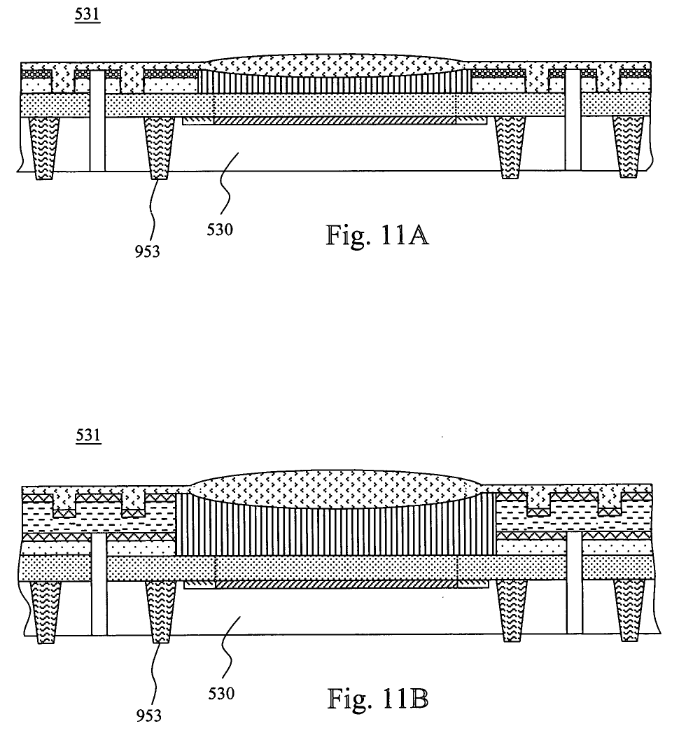

FIG. 11A and FIG. 11B illustrate schematic views of the substrate which is thinned from lower surfaces of the substrate illustrated in FIG. 10A and 10B, respectively. The substrate 530 in FIG. 10A or FIG. 10B is thinned by backside grinding, chemical mechanical polishing (CMP), high selective plasma etching or wet etching from the lower surface 745, so that bottom ends of the stitching plugs 646 are exposed from the lower surface 745 of the substrate 530, as illustrated in FIG. 11A and FIG. 11B. Stitching studs 953 are then formed from the stitching plugs 646 to be outer electrode connecting ports. Moreover, the stitching studs 953 can be coated with layers of UBM (Under Bump Metallurgy) (not illustrated in FIG. 11A and FIG. 11B).

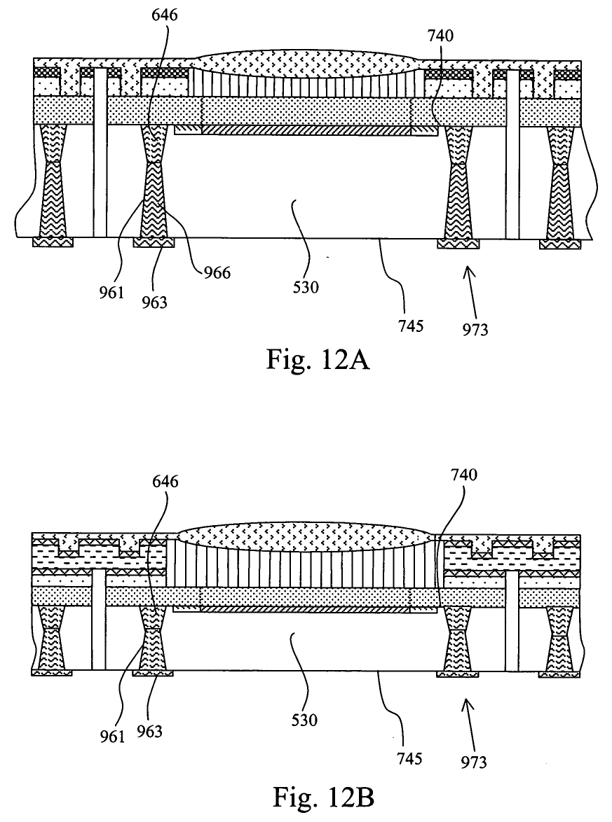

FIG. 12A and FIG. 12B illustrate schematic views of another preferred embodiments of the invention. Backside trenches 961 are formed in the lower surface 745 of the substrate 530, which are expected to match up with the embedded frontside stitching plugs 646 with insulating films previously formed on the upper surface 740 of the substrate 530. As a result, the trenches 961 are completely coupled to the stitching plugs 646 through the substrate 530. It is noted that, in this embodiment, the substrate 530 can be thinned before the backside trenches 961 are formed, or after the stitching plugs 966 are formed.

The backside trenches 961 are formed by chemical etching, plasma etching or laser drilling from the backside surface 745. An insulating film is then formed on the exposed surfaces of backside trenches 961 from silicon oxidation, silicon nitride or polymer resin. Afterwards, the backside trenches 961 having insulating film are filled with conductive materials, such as titanium, titanium nitride, solder, copper, mercury, amalgam, aluminum, silver epoxy, conductive polymer, other conductive material or combinations thereof, to form conductive stitching plugs 966.

The lower surface 745 of the substrate 530 is sequentially patterned and etched to form stitching stud pads 963, thus forming the stitching studs 973. In another embodiment, simple stitching studs are formed merely by the stitching plugs 966 and the insulating film, without the additional stitching stud pads 963.

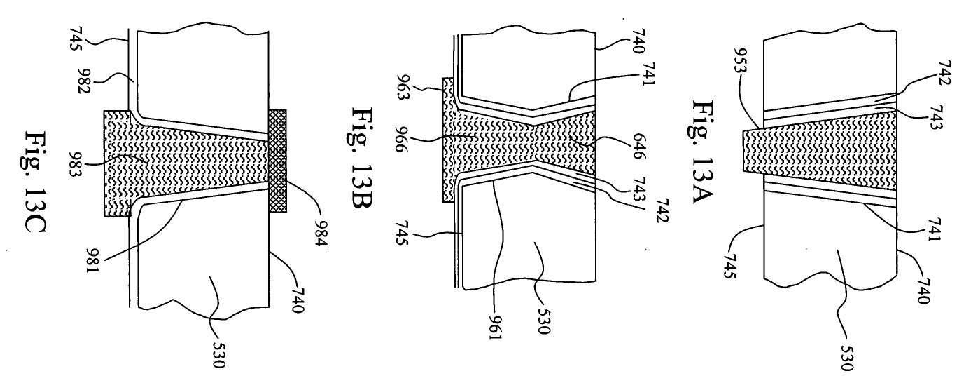

The stitching studs of the invention can be formed many alternate ways. FIGS. 13A-13C illustrate schematic views of three embodiments of the invention with the stitching studs formed in different ways. The two embodiments in FIG. 13A and FIG. 13B are interpreted as for the foregoing descriptions for FIG. 11A, FIG. 11B, and FIG. 12A, FIG. 12B.

As illustrated in FIG. 13C, after thinning the substrate 530 or not, backside stitching stud 983 is formed by a single backside trench 981 which passes thorough the substrate 530 from the lower surface 745 to the upper surface 740 thereof, and also is covered with a insulating film 982. The stitching stud 983 is connected to an electrical connecting layer 984 whose material is a poly layer or polycide, a contact plug, or a metal layer fabricated in the conventional image pickup device.

The foregoing image pickup device of the invention is further able to be associated with an image control module, a flexible conductive element and the like, thus being a compact imaging module device suitable for a unit of portable electronic equipment.

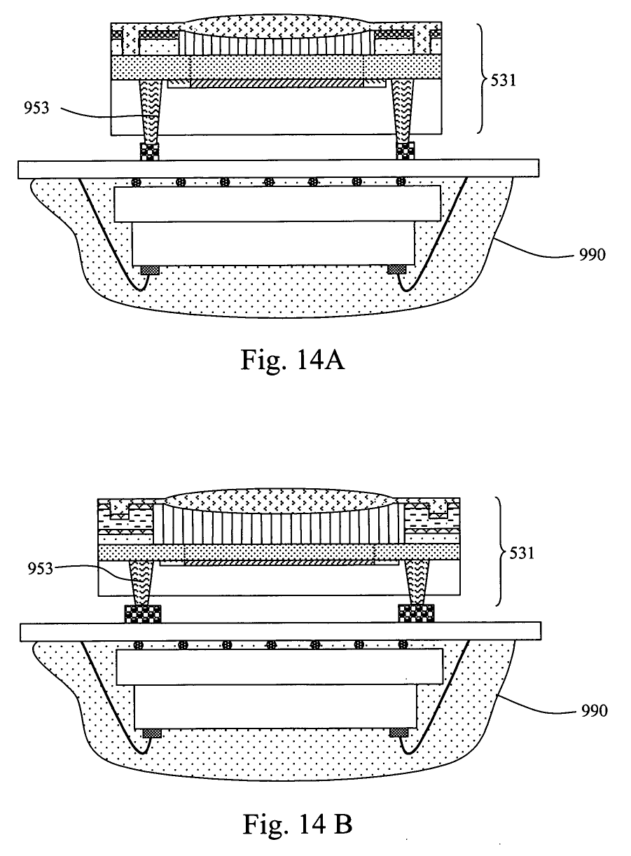

FIG. 14A and FIG. 14B illustrate schematic views of preferred embodiments of the image pickup device associated with an image control module, and the embodiment in FIG. 14B has an additional sustain layer 965 rather than the embodiment in FIG. 14A. Referring to FIG. 14A and FIG. 14B, a thin and compact imaging module is formed by the foregoing image chip 531 in FIG. 11A or FIG. 11B and associated with and electrically connected to an image control module, such as an integrated module circuit board 990 by the stitching studs 953. The integrated module circuit board 990 has highly integrated image related function blocks, such as system microcontrollers, digital signal processing units, system timing ASICs, memory buffers, and peripheral controller devices.

Several packaging connection techniques and materials, such as an isotropic conductive adhesive used in the studs bumping bonding, other conventional techniques surface mounting, anisotropic connection film (ACF), gold or solder bumping, wiring, ball grid array, flexible cable and/or flip chip, can be used in the electrical connecting between the stitching studs 953 and the electrode ports of the integrated module circuit board 990, to form an integrated compact imaging module.

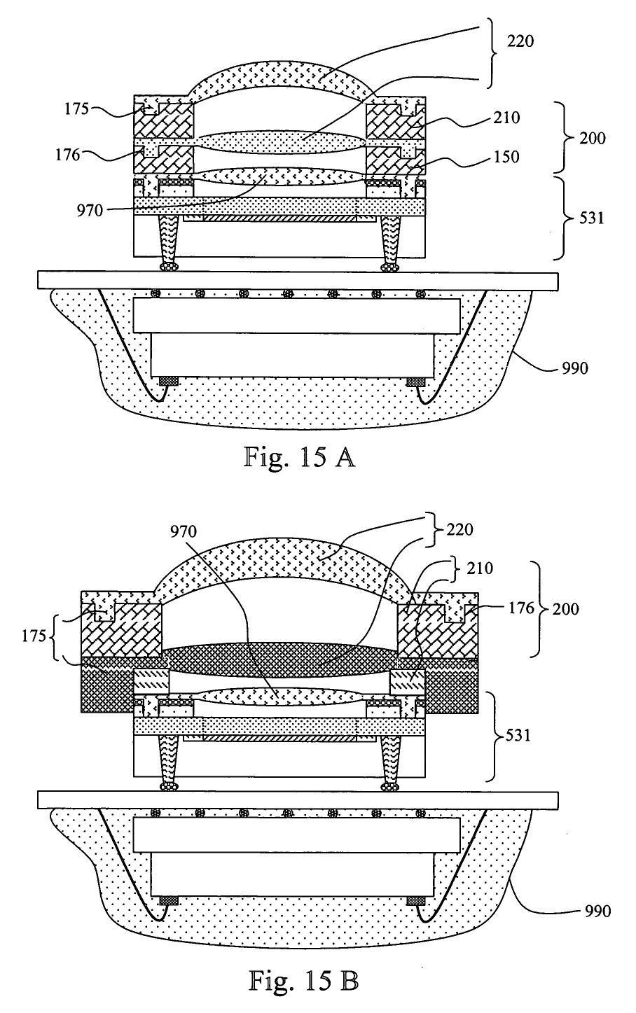

FIG. 15A and FIG. 15B illustrate schematic views of two embodiments of the imaging module of the invention, which have fixed focal lengths. FIG. 15B interprets another combined configuration of the optical lens system and the transparent window different from that illustrated in FIG. 15A. Referring to FIG. 15A and FIG. 15B, an optical lens system 200 includes a plurality of adhesive layer 210 and optics lenses 220. The optical lenses 220 can include different spherical, aspherical, diffractive and/or refractive optical elements, or other refractive or diffractive optical elements obtained by hybridly combined flat, spherical, aspherical, or Kinoform surfaces.

The optical lens system 200 can be directly configured on the upper surface of the transparent window 970 by an adhesive layer 150, even more by inserting a sustain layer therebetween (not illustrated in figures) to combine the optical lens system 200 with the transparent window 970. In addition, a plurality of extrusions 175 can be formed in the optical lenses 220, and corresponding holes 176 are also formed in the adhesive layer 210, thus facilitating the mechanical alignments.

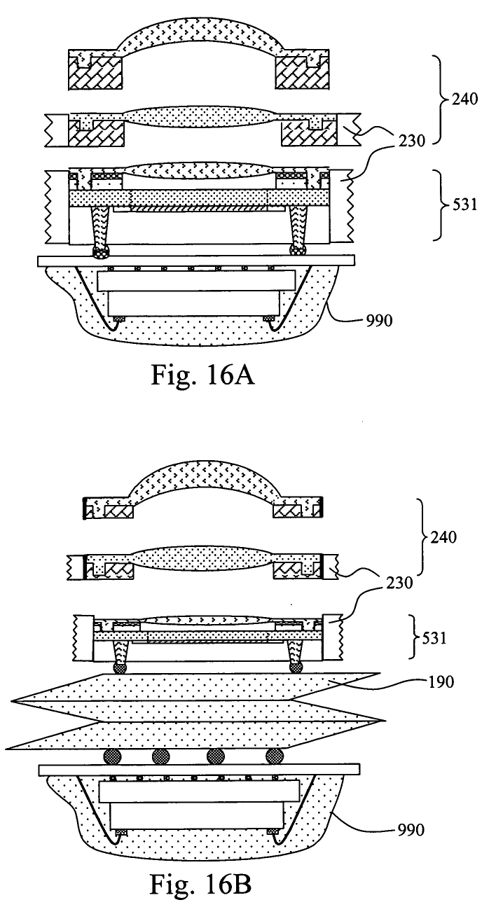

FIG. 16A and FIG. 16B illustrate schematic views of two embodiments of the imaging module of the invention, which have adjustable focal lengths. FIG. 16B interprets another combined configuration of the optical lens system and the transparent window different from that in FIG. 16A. In FIG. 16A and 16B, a zoom optical lens system 240 is provided, which uses zoom parts 230 between the optical lens system 240 and the image chip 531. In the preferred embodiments of the invention, the zoom parts 230 can be mechanical parts, electromagnetic force parts, motors, other types of zoom system or combinations thereof. A feature of the zoom parts 230 of the invention is achieve focus by moving the relative location of the image chip 531, which may include the integrated module circuit board 990 as illustrated in FIG. 16A or only itself as illustrated in FIG. 16B, along the optical axis thereof for improving and magnifying an object image.

It is noted that the image chip 531 can be electrically connected to the integrated module circuit board 990 with a flexible conductive element 190, as illustrate in FIG. 16B. In some preferred embodiments, the flexible conductive element 190 is a flexible circuit board, a conductive cable or member, or conductive polymer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An image pickup device, comprising:
a substrate;
an electromagnetic receiving area on the substrate;
a peripheral circuit around the electromagnetic receiving area, and electrically connected to the electromagnetic receiving area; and
a plurality of stitching studs passing through the substrate, and electrically connected to the peripheral circuit.

2. The image pickup device of claim 1, wherein the image pickup device further comprises a transparent window, attached onto the substrate and located above the electromagnetic receiving area.

3. The image pickup device of claim 2, wherein the image pickup device further comprises an adhesive layer placed between the substrate and the transparent window.

4. The image pickup device of claim 2, wherein the image pickup device further comprises a sustain layer placed between the substrate and the transparent window.

5. The image pickup device of claim 2, wherein the image pickup device further comprises a plurality of holes and corresponding extrusions formed on adjacent surfaces of the substrate and the transparent window.

6. The image pickup device of claim 1, wherein the electromagnetic receiving area comprises a plurality of electromagnetic receiving elements.

7. An imaging module, comprising:
an image pickup device, comprising:
a substrate;
an electromagnetic receiving area on the substrate;
a peripheral circuit around the electromagnetic receiving area, and electrically connected to the electromagnetic receiving area; and
a plurality of stitching studs passing through the substrate, and electrically connected to the peripheral circuit;
an optical lens system, configured on the image pickup device with respect to the electromagnetic receiving area; and
an image control module, electrically connected to the stitching studs.

8. The imaging module of claim 7, wherein the image pickup device further comprises a transparent window, attached onto the substrate and located above the electromagnetic receiving area.

9. The imaging module of claim 7, wherein the imaging module further comprises an adhesive layer placed between the image pickup device and the optical lens system.

10. The imaging module of claim 7, wherein the imaging module further comprises a sustain layer placed between the image pickup device and the optical lens system.

11. The imaging module of claim 7, wherein the imaging module further comprises a plurality of holes and corresponding extrusions formed on adjacent surfaces of the image pickup device and the optical lens system.

12. The imaging module of claim 7, wherein the optical lens system is a fixed focal length type optical lens system or an adjustable focal length optical lens system.

13. The imaging module of claim 12, wherein when the optical lens system is the adjustable focal length optical lens system, the optical lens system and the image pickup device are configured with zoom parts to adjust a relative distance therebetween.

14. The imaging module of claim 7, wherein the imaging module further comprises a flexible conductive element connecting the image pickup device and the image control module.

15. A manufacturing method of an image pickup device, comprising:
providing a substrate;
forming an electromagnetic receiving area on a first surface of the substrate;
forming a peripheral circuit around the electromagnetic receiving area, wherein the peripheral circuit is connected to the electromagnetic receiving area; and
forming a plurality of stitching studs passing through the substrate, wherein the stitching studs are connected to the peripheral circuit.

16. The manufacturing method of claim 15, wherein the manufacturing method further comprises attaching a transparent window onto the substrate, wherein the transparent window is located above the electromagnetic receiving area.

17. The manufacturing method of claim 16, wherein the attaching step comprises providing an adhesive layer between the substrate and the transparent window.

18. The manufacturing method of claim 16, wherein the attaching step comprises forming a sustain layer between the substrate and the transparent window.

19. The manufacturing method of claim 16, wherein the attaching step comprises:
forming a plurality of holes and corresponding extrusions on adjacent surfaces of the substrate and the transparent window; and
matching the holes with the extrusions to combine the substrate and the transparent window.

20. The manufacturing method of claim 15, wherein the electromagnetic receiving area comprises a plurality of electromagnetic receiving elements.

21. The manufacturing method of claim 15, wherein the step of forming the stitching studs comprises:
forming a plurality of trenches in the first surface of the substrate;
forming insulating films inside the trenches;
filling the trenches with a conductive material to form a plurality of stitching plugs; and
thinning a second surface of the substrate to expose ends of the stitching plugs, thus obtaining the stitching studs.

22. The manufacturing method of claim 15, wherein the step of forming the stitching studs comprises:
forming a plurality of trenches in a second surface of the substrate;
forming insulating films inside the trenches; and
filling the trenches with a conductive material to form the stitching studs.

23. The manufacturing method of claim 15, wherein the step of forming the stitching studs comprises:
forming a plurality of first trenches in the first surface of the substrate;
forming a plurality of second trenches in a second surface of the substrate, wherein the second trenches match up with the first trenches;
forming insulating films inside the trenches; and
filling the trenches with a conductive material to form the stitching studs.

24. The manufacturing method of claim 23, wherein the steps of forming the insulating films inside and filling the first trenches and the second trenches with a conductive material are separate steps.

25. A manufacturing method of an imaging module, comprising:
providing an image pickup device, comprising:
providing a substrate;
forming an electromagnetic receiving area on a first surface of the substrate;
forming a peripheral circuit around the electromagnetic receiving area, wherein the peripheral circuit is connected to the electromagnetic receiving area; and
forming a plurality of stitching studs passing through the substrate, wherein the stitching studs are connected to the peripheral circuit;
configuring an optical lens system on the image pickup device with respect to the electromagnetic receiving area; and
electrically connecting an image control module to the stitching studs.

26. The manufacturing method of claim 25, wherein the manufacturing method further comprises attaching a transparent window onto the substrate, wherein the transparent window is located above the electromagnetic receiving area.

27. The manufacturing method of claim 25, wherein the configuring step comprises providing an adhesive layer between the image pickup device and the optical lens system.

28. The manufacturing method of claim 25, wherein the configuring step comprises forming a sustain layer between the image pickup device and the optical lens system.

29. The manufacturing method of claim 25, wherein the configuring step comprises:
forming a plurality of holes and corresponding extrusions on adjacent surfaces of the image pickup device and the optical lens system; and
matching the holes with the extrusions to combine the image pickup device and the optical lens system.

30. The manufacturing method of claim 25, wherein the step of forming the stitching studs comprises:
forming a plurality of trenches in the first surface of the substrate;
forming insulating films inside the trenches;
filling the trenches with a conductive material to form a plurality of stitching plugs; and
thinning a second surface of the substrate to expose ends of the stitching plugs, thus obtaining the stitching studs.

31. The manufacturing method of claim 25, wherein the step of forming the stitching studs comprises:
forming a plurality of trenches in a second surface of the substrate;
forming insulating films inside the trenches; and
filling the trenches with a conductive material to form the stitching studs.

32. The manufacturing method of claim 25, wherein the step of forming the stitching studs comprises:
forming a plurality of first trenches in the first surface of the substrate;
forming a plurality of second trenches in a second surface of the substrate, wherein the second trenches match up with the first trenches;
forming insulating films inside the trenches; and
filling the trenches with a conductive material to form the stitching studs.

33. The manufacturing method of claim 32, wherein the steps of forming the insulating films inside and filling the first trenches and the second trenches with a conductive material are separate steps.

34. The manufacturing method of claim 25, wherein the optical lens system is a fixed focal length type optical lens system or an adjustable focal length optical lens system.

35. The manufacturing method of claim 34, wherein when the optical lens system is the adjustable focal length optical lens system, the manufacturing method further comprises configuring zoom parts on the optical lens system and the image pickup device to adjust a relative distance therebetween.

36. The manufacturing method of claim 25, wherein the electrically connecting step comprises electrically connecting the image pickup device and the image control module with a flexible conductive element.

37. The manufacturing method of claim 25, wherein the image pickup device and the image control module are electrically connected by an isotropic conductive adhesive used in studs bumping bonding, surface mounting, anisotropic connection film (ACF), gold or solder bumping, wiring, ball grid array, flexible cable or flip chip.
